(19) United States
(12) Patent Application Publication
(10) Pub. No.: US 2025/0309493 A1
(43) Pub. Date: Oct. 2, 2025

(54) SECONDARY BATTERY AND ELECTRICAL DEVICE

(71) Applicant: Ningde Amperex Technology Limited, Ningde (CN)

(72) Inventors: Jianpeng CHEN, Ningde (CN); Luming MA, Ningde (CN); Mingliang MO, Ningde (CN)

(73) Assignee: Ningde Amperex Technology Limited, Ningde (CN)

(21) Appl. No.: 19/093,841

(22) Filed: Mar. 28, 2025

(30) Foreign Application Priority Data
Mar. 30, 2024 (CN) 202410383361.2

(51) Int. Cl. H01M 50/533; H01M 10/0585; H01M 50/105; H01M 50/178; H01M 50/186; H01M 50/191; H01M 50/54

(52) U.S. Cl. CPC H01M 50/533; H01M 10/0585; H01M 50/105; H01M 50/178; H01M 50/186; H01M 50/191; H01M 50/54

(57) ABSTRACT

A secondary battery includes a positive electrode plate and a negative electrode plate. The positive electrode plate includes a positive electrode plate body and a first tab portion. The positive electrode plate body is provided with a first notch and a second notch. The first tab portion is located at the first notch. The negative electrode plate includes a negative electrode plate body, a second tab portion, and a third tab portion. The negative electrode plate body is provided with a third notch and a fourth notch. The second tab portion is located at the third notch. The third tab portion is located at the fourth notch. Viewed along a third direction, a projection of the first tab portion at least partially overlaps with a projection of the second tab portion.

### CROSS REFERENCE TO RELATED APPLICATION

This application claims priority to the Chinese Patent Application Ser. No. 202410383361.2, filed on Mar. 30, 2024, the content of which is incorporated herein by reference in its entirety.

### TECHNICAL FIELD

This application relates to the field of battery technology, and in particular, to a secondary battery and an electrical device.

### BACKGROUND

In a stacking process, tab portions on both a positive electrode plate and a negative electrode plate are obtained by cutting (such as laser cutting) a blank region of a foil on one or both sides. The positive electrode plate with a tab portion, the negative electrode plate with a tab portion, and a separator that separates the positive electrode plate from the negative electrode plate are stacked together by just hot-pressing, and then the stacked structure is typically adsorbed by adsorption equipment and then transferred to a subsequent process. During the transfer of the stacking structure, for lack of constraints on the tabs on the positive and negative electrode plates, the wobbling of the tab portions causes lifting of the root portion, and the lifting spreads to the electrode plate body containing the tab portion, thereby reducing the adhesion between the positive and negative electrode plates and the separator, and in turn, impairing the yield rate of the secondary battery.

### SUMMARY

An objective of this application is to provide a secondary battery and an electrical device to alleviate the phenomenon that the adhesion between a positive or negative electrode plate and a separator decreases due to wobbling of a tab portion.

According to a first aspect of this application, a secondary battery is provided, including an electrode assembly. The electrode assembly assumes a stacked structure, and includes a positive electrode plate, a negative electrode plate, and a separator that separates the positive electrode plate from the negative electrode plate. The positive electrode plate includes a positive electrode plate body and a first tab portion. The positive electrode plate body includes a first edge. The first edge is provided with a first notch and a second notch. The first notch and the second notch are spaced apart from each other along a first direction. The first tab portion is located at the first notch and is formed together with the positive electrode plate body in one piece, and the first tab portion exceeds the first edge along a second direction. The negative electrode plate includes a negative electrode plate body, a second tab portion, and a third tab portion. The negative electrode plate body includes a second edge, and the second edge is provided with a third notch and a fourth notch. The second tab portion is located at the third notch and is formed together with the negative electrode plate body in one piece. The third tab portion is located at the fourth notch and is formed together with the negative electrode plate body in one piece. The third tab portion exceeds the second edge along the second direction. Viewed along a third direction, a projection of the third notch lies within a projection of the first notch, and a projection of the fourth notch lies within a projection of the second notch; and a projection of the first tab portion at least partially overlaps with a projection of the second tab portion. A length of the second tab portion in the second direction is less than a length of the first tab portion in the second direction. Any two of the third direction, the second direction, or the first direction are perpendicular to each other. The third direction is a stacking direction of the negative electrode plate and the positive electrode plate.

In a secondary battery designed above, each tab portion of the positive electrode plate and the negative electrode plate is disposed in a corresponding notch. In contrast to the prior art in which the length of each tab portion is basically kept unchanged, the length by which each tab portion extends out of the electrode plate body along the second direction becomes shorter, thereby reducing the wobbling amplitude of the first tab portion, the second tab portion, and the third tab portion during the transfer, and in turn, reducing the phenomena that the wobbling of the first tab portion, the second tab portion, and the third tab portion causes lifting of the root portion and that the lifting spreads to the electrode plate body containing the tab portion. On this basis, because the length of the second tab portion in the second direction is less than the length of the first tab portion in the second direction, the wobbling amplitude of the first tab portion sandwiched between two adjacent second tab portions can be further suppressed due to the constraint effect of the two adjacent second tab portions. Therefore, the secondary battery of this application can alleviate the phenomenon that the adhesion between the positive or negative electrode plate and the separator is reduced, thereby improving the yield rate of the secondary battery.

In one or more optional embodiments, the negative electrode plate body includes a negative current collector and a first negative active material layer disposed on at least one surface of the negative current collector. The positive electrode plate body includes a positive current collector and a first positive active material layer disposed on at least one surface of the positive current collector. The secondary battery further includes a second negative active material layer. In the third direction, the second negative active material layer is disposed on two opposite surfaces of the second tab portion, and the second negative active material layer and the first negative active material layer are formed in one piece. The secondary battery includes a second positive active material layer. The first notch includes a first bottom edge. The second positive active material layer is disposed on two opposite surfaces of the first tab portion in the third direction and is disposed close to the first bottom edge. The second positive active material layer and the first positive active material layer are formed in one piece. In the second direction, a distance from the first edge to the first bottom edge is c mm, and a distance from one end, away from the first bottom edge, of the second positive active material layer to the first bottom edge is c1 mm, satisfying: 0<|c1−c|≤0.05 mm.

On the premise that other conditions of the secondary battery remain basically the same, the second tab portion and the region corresponding to the second tab portion can be sufficiently utilized. With more active material added, the area of the active material can be increased, thereby increasing the energy density of the secondary battery. In addition, when a second positive active material layer is disposed at one end, close to the first bottom edge, of the first tab portion, because the second tab portion is also provided with the second negative active material layer, the normal length by which the second bottom edge of the third notch extends beyond the first bottom edge along the second direction can be maintained without a need to move the entire positive electrode plate downward. The downward movement of the entire positive electrode plate leads to an excessive length by which the second edge extends beyond the first edge along the second direction, and therefore, the gap at the head of the secondary battery becomes larger, and results in a decrease in the volumetric energy density of the secondary battery.

In one or more optional embodiments, the secondary battery includes an adhesive component. In the third direction, the adhesive component is adhesively fixed between the second tab portion and the separator. In this way, the adhesive component bonds the second tab portion and the separator together to increase the structural strength of the second tab portion, thereby enhancing the restraint effect on the first tab portion, and further alleviating the decrease in the adhesion between the positive electrode plate and the separator.

In one or more optional embodiments, the secondary battery includes a packaging bag, a positive tab, and a negative tab. The electrode assembly is accommodated in the packaging bag. The number of the positive electrode plates, the number of the negative electrode plates, and the number of the separators each are at least two. Along the third direction, the positive electrode plates and the negative electrode plates are alternately stacked. The separator is sandwiched between any one positive electrode plate and a negative electrode plate adjacent to the positive electrode plate. Along the second direction, a part, exceeding the first edge, of the first tab portion is a first exceeding part. At least a part of the first exceeding part is configured to bend and extend along the third direction and be electrically connected to the positive tab. Along the second direction, a part, exceeding the second edge, of the third tab portion is a second exceeding part. At least a part of the second exceeding part is configured to bend and extend along the third direction and be electrically connected to the negative tab.

In the above technical solution, in the third direction, the first notch and the third notch overlap to form a tab portion accommodation space for accommodating the bent first tab portion. Similarly, in the third direction, the second notch and the fourth notch overlap to form a tab portion accommodation space for accommodating the bent third tab portion. The bending of the first tab portion and the third tab portion can reduce the space occupied by the electrode assembly, thereby reducing the head gap of the secondary battery, and in turn, increasing the volumetric energy density of the secondary battery.

In one or more optional embodiments, the secondary battery includes an insulation layer. The insulation layer is disposed peripherally on an outer peripheral surface of the first exceeding part at one end close to the first notch. Viewed along the third direction, an edge of the second tab portion on one side away from the third notch lies within a projection of the insulation layer. The outer peripheral surface of the first exceeding part at one end close to the first notch is provided with an insulation layer. In addition, when viewed along the third direction, an edge of the second tab portion on one side away from the third notch is located inside the projection of the insulation layer. Therefore, even if the burrs of the second tab portion caused by laser cutting pierce the separator, the burrs are not prone to directly contact the first exceeding part of an opposite polarity, thereby improving the reliability of the secondary battery in use.

In one or more optional embodiments, (c−a)≤f. With the value of f falling within this range, the risk of lithium plating of the secondary battery is relatively low, a relatively high percentage increase in the adhesion and the volumetric energy density can be maintained. Along the second direction, the third notch includes a second bottom edge. A distance from the second bottom edge to the first bottom edge is a mm.

In one or more optional embodiments, f≤Min{(b+c−a)/2, (e+c−a)}. With the value of f falling within this range, the length by which the second tab portion extends out in the second direction is less likely to cause the bent first tab portion to additionally occupy the head gap of the secondary battery, a relatively high percentage increase in the adhesion can be maintained, and a percentage increase in the volumetric energy density is also achieved. In the relational expression above, along the second direction, a distance between the second edge and the first edge is b mm; and, along the second direction, a coating length of the insulation layer is e mm.

In one or more optional embodiments, the insulation layer is a ceramic coating layer.

In one or more optional embodiments, the separator includes a third edge. The third edge, the second edge, and the first edge are all located on a same side of the electrode assembly. The third edge is provided with a fifth notch and a sixth notch.

Viewed along the third direction, a projection of the fifth notch lies within the projection of the first notch, and a projection of the sixth notch lies within the projection of the second notch. In this way, the entire head of the separator is not prone to bend as driven by the bending of the first tab portion and the second tab portion, thereby reducing the probability of a short circuit between the positive electrode plate body and the negative electrode plate body caused by the inward bending of the head portion of the separator.

According to a second aspect of this application, an electrical device is provided. The electrical device includes the secondary battery disclosed above.

Additional aspects and advantages of some embodiments of this application will be partly described or illustrated herein later or expounded through implementation of an embodiment of this application.

### BRIEF DESCRIPTION OF DRAWINGS

To describe the technical solutions in the specific embodiments of this application or the prior art more clearly, the following outlines the drawings that need to be used in the descriptions of the specific embodiments of this application or the prior art. In all the drawings, similar elements or parts are generally identified by similar reference numerals. The elements or parts in the drawings are not necessarily drawn to scale.

FIG. 1 is a schematic structural diagram of a secondary battery according to an embodiment of this application;

FIG. 2 is a structural exploded view of the secondary battery shown in FIG. 1;

FIG. 3 is a partial cross-sectional view of sectioning along an A-A′ line shown in FIG. 1;

FIG. 4 is a partial cross-sectional view of sectioning along a B-B′ line shown in FIG. 1;

FIG. 5 is a schematic structural diagram of a composite unit in an electrode assembly;

FIG. 6 is a close-up view of a part a shown in FIG. 5;

FIG. 7 is a close-up view of a part b shown in FIG. 5;

FIG. 8 is a schematic structural diagram of another secondary battery according to an embodiment of this application;

FIG. 9 is a partial cross-sectional view of sectioning along a C-C′ line shown in FIG. 8; and

FIG. 10 is a partial cross-sectional view of sectioning along a D-D′ line shown in FIG. 8.

### LIST OF REFERENCE NUMERALS

10. packaging bag;
11. first bag body; 12. second bag body;
20. electrode assembly;
21. positive electrode plate; 211. positive electrode plate body; 2111. first edge; 21a. first notch; 2114. first bottom edge; 21b. second notch; 212. first tab portion; 2121. first exceeding part;
22. negative electrode plate; 2211. second edge; 22a. third notch; 2214. second bottom edge; 22b. fourth notch; 2217. third bottom edge; 222. second tab portion; 223. third tab portion; 2231. second exceeding part;
23. separator; 2311. third edge; 23a. fifth notch; 23b. sixth notch;
31. positive tab; 32. negative tab; 33. first tab portion convergence section; 34. third tab portion convergence section;
41. second positive active material layer; 42. second negative active material layer; 43. insulation layer.

### DETAILED DESCRIPTION

To make the objectives, technical solutions, and advantages of the embodiments of this application clearer, the following gives a clear description of the technical solutions in some embodiments of this application with reference to the drawings in some embodiments of this application. Evidently, the described embodiments are merely a part rather than all of the embodiments of this application.

Reference to “embodiment” in this application means that a specific feature, structure or characteristic described with reference to the embodiment may be included in at least one embodiment of this application. Reference to this term in different places in the specification does not necessarily represent the same embodiment, nor does it represent an independent or alternative embodiment in a mutually exclusive relationship with other embodiments.

In the description of this application, unless otherwise expressly specified and defined, the terms such as “mount” and “connect” need to be understood in a broad sense. For example, a “connection” may be a fixed connection, a detachable connection, or an integrated connection; or may be a direct connection or an indirect connection implemented through an intermediary; or may be internal communication between two components. A person of ordinary skill in the art is able to understand the specific meanings of the terms in this application according to specific situations.

To the extent that no mutual conflict occurs, the technical features described below in different embodiments of this application may be combined with each other.

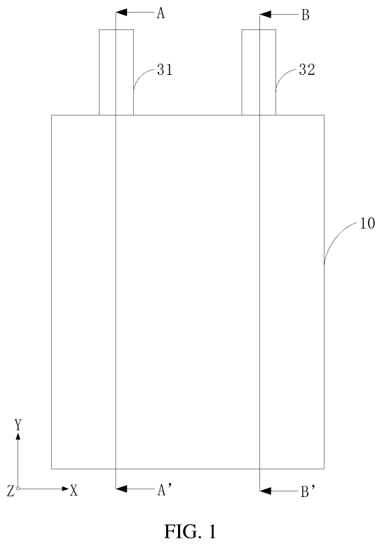

For ease of description, as shown in FIG. 1 to FIG. 7, a three-dimensional rectangular coordinate system is established in which the width direction of the secondary battery is a first direction X, the length direction of the secondary battery is a second direction Y, and the thickness direction of the secondary battery is a third direction Z.

In some embodiments, the first direction X is parallel to a direction in which the first notch 21a and the second notch 22a are spaced apart from each other, the details of which will be described below. In addition, the first direction X is also parallel to a direction in which the second tab portion 222 and the third tab portion 223 are spaced apart from each other, the details of which will be described below.

In some embodiments, the second direction Y is parallel to an extension-out direction of each tab portion in the electrode assembly, the details of which will be described below. In addition, the second direction Y is also parallel to the extension-out direction of the positive tab 31 and the negative tab 32, the details of which will be described below.

In some embodiments, the third direction Z is parallel to a stacking direction of the electrode plates in the electrode assembly, the details of which will be described below.

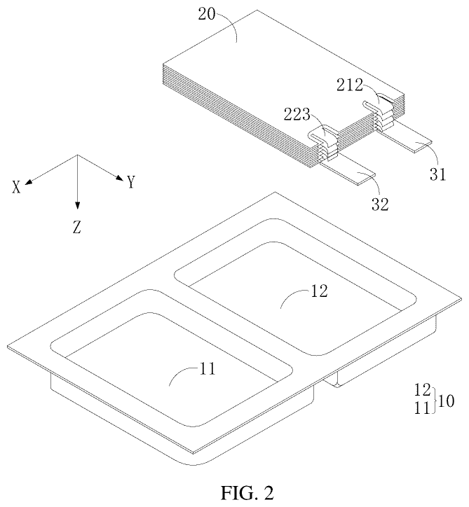

FIG. 1 is a schematic structural diagram of a secondary battery according to an embodiment of this application, and FIG. 2 is a structural exploded view of the secondary battery shown in FIG. 1. First, referring to the examples shown in FIG. 1 and FIG. 2, the secondary battery includes: a packaging bag 10; an electrode assembly 20, accommodated in an accommodation cavity of the packaging bag 10; a positive tab 31, one end of which is electrically connected to the electrode assembly 20, and the other end of which protrudes out of the packaging bag 10; and a negative tab 32, one end of which is electrically connected to the electrode assembly 20, and the other end of which protrudes out of the packaging bag 10. Both a part, protruding out of the packaging bag 10, of the positive tab 31 and a part, protruding out of the packaging bag 10, of the negative tab 32 can be electrically connected to an external device to implement charging and discharging of the secondary battery.

In some embodiments, the secondary battery includes an electrolyte. The electrolyte is accommodated in the accommodation cavity of the packaging bag 10. The electrode assembly 20 is infiltrated in the electrolyte.

Regarding the packaging bag 10, in some embodiments, the packaging bag 10 is made of a packaging film. Specifically, the packaging film includes a first polymer layer (not shown in the drawing), a metal layer (not shown in the drawing), and a second polymer layer (not shown in the drawing) arranged in sequence from inside outward.

The first polymer layer melts at a preset temperature, and is of a viscosity to facilitate packaging with the packaging bag 10. As an example, the first polymer layer may be made of a polypropylene material. In this way, the first polymer layer is hardly dissolvable or swellable in an electrolyte solution, thereby reducing the risk of corrosion of a metal layer adjacent to the first polymer layer.

The metal layer is configured to reduce the probability that moisture penetrates into the inner cavity to generate gas-liquid exchange with the electrolyte solution. As an example, the metal layer may be made of an aluminum material. The aluminum material reacts with oxygen in the air to form a dense oxide film to prevent moisture from penetrating into the interior of the packaging bag 10.

Definitely, the metal layer may be made of various materials. For example, in some other embodiments, the metal layer may be one selected from steel, titanium, or alloy.

The second polymer layer can reduce the probability of air penetration into the inner cavity of the packaging bag 10, and can improve the deformability of the packaging bag 10. As an example, the second polymer layer may be made of a nylon material.

For another example, in some other embodiments, the packaging film may be made of only a single polymer layer such as polyethylene, polypropylene, or anhydride-modified polypropylene.

Understandably, when the packaging bag 10 is made of a packaging film, the specific shape of the packaging bag 10 depends on the shape of the electrode assembly 20 due to the deformability of the packaging film. In other words, the shape of the packaging bag 10 may match the shape of the electrode assembly 20 contained in the bag.

Still referring to FIG. 2, in some embodiments, the packaging bag 10 includes a first bag body 11 and a second bag body 12. The first bag body 11 and the second bag body 12 are hermetically connected. At least one of the first bag body 11 or the second bag body 12 may be made into a recessed accommodation cavity by using a drawing tool such as a stamping press. The electrode assembly 20 may be accommodated in the accommodation cavity. For ease of description, an example is used here in which the first bag body 11 in FIG. 2 defines an accommodation cavity and the second bag body 12 also defines an accommodation cavity. The first bag body 11 extends outward from all sides of the accommodation cavity to form a plurality of connecting edges. The plurality of connecting edges of the first bag body 11 may be connected to the periphery of the second bag body 12 by melting, but the connection manner is not limited to melting connection. In this way, a plurality of sealing portions connected sequentially to seal the accommodation cavity.

As can be seen from FIG. 2, one side of the first bag body 11 may be connected to one side of the second bag body 12. However, this application is not limited to the sample. For example, the first bag body 11 and the second bag body 12 may be manufactured separately and separated from each other.

In some embodiments, the electrode assembly 20 assumes a stacked structure and includes a positive electrode plate 21, a negative electrode plate 22, and a separator 23. The number of the positive electrode plates 21, the number of the negative electrode plates 22, and the number of the separators 23 each are at least two. Along the third direction, the positive electrode plates 21 and the negative electrode plates 22 are alternately stacked. The separator 23 is sandwiched between any one positive electrode plate 21 and a negative electrode plate 22 adjacent to the positive electrode plate, so that the positive electrode plate 21 is insulated from the negative electrode plate 22.

It is worth mentioning that the electrode assembly 20 in each embodiment of this application needs to meet the following requirements: the width of the separator 23 in the second direction Y is greater than the width of the negative electrode plate 22 in the second direction Y, and the width of the negative electrode plate 22 in the second direction Y is greater than the width of the positive electrode plate 21 in the second direction Y. In this way, the separator 23 can provide an additional safety margin to reduce the probability of a short circuit caused by direct contact between the positive electrode plate 21 and the negative electrode plate 22. In addition, the region in which the negative electrode plate 22 exceeds the positive electrode plate 21 along the second direction Y can adjust the capacities of the positive electrode and the negative electrode, thereby alleviating the safety hazards posed by lithium plating on the surface of the negative electrode plate 22 caused by the excess lithium ions that are deintercalated from the positive electrode plate 21 and unable to be fully intercalated into the negative active material during charging of the secondary battery.

The positive electrode plate 21 includes a positive electrode plate body 211 and a first tab portion 212. The positive electrode plate body includes a positive current collector (not shown in the drawing) and a first positive active material layer (not shown in the drawing) disposed on at least one surface of the positive current collector. The first tab portion 212 is formed together with the positive current collector in one piece.

The positive current collector and the first tab portion 212 are typically made of a material that is highly conductive but without causing chemical changes. Examples of such materials include, but are not limited to, stainless steel, aluminum, nickel, calcined carbon, or surface-treated aluminum or stainless steel that is formed by treating the surface with carbon, nickel, titanium, silver, or the like. Understandably, the structure of the positive current collector is diversified, and may be, for example, a film, a sheet, a foil, a mesh, a porous body, a foam, or a nonwoven fabric.

In a case that the secondary battery is a lithium secondary battery, the first positive active material layer includes a positive active material. The positive active material may include, but is not limited to: (i) a layered compound of lithium cobalt oxide, lithium nickel oxide, lithium nickel cobalt manganese oxide, lithium nickel cobalt aluminum oxide, lithium manganese oxide, lithium nickel oxide, lithium manganese iron phosphate, lithium vanadium phosphate, lithium iron phosphate, or the like; or (ii) a compound substituted by one or more transition metals, for example, lithium manganese oxide, such as Li₁₊ₓMn₂₋ₓO₄ (x is 0 to 0.33), LiMnO₃, LiMn₂O₃, or LiMnO₂; lithium copper oxide (Li₂CuO₂); vanadium oxide such as LiV₃O₈, LiFe₃O₄, V₂O₅, or Cu₂V₂O₇.; a nickel-site type lithium nickel oxide represented by the chemical formula LiNi₁₋ₓMₓO₂ (M=Co, Mn, Al, Cu, Fe, Mg, B, or Ga, x=0.01 to 0.3); or a lithium manganese composite oxide represented by the chemical formula LiMn₂₋ₓMₓO₂ (M=Co, Ni, Fe, Cr, Zn, or Ta, and x=0.01 to 0.1) or Li₂Mn₃MO₈ (M=Fe, Co, Ni, Cu, or Zn); LiMn₂O₄ in which a part of lithium is substituted by alkaline earth ions; disulfide compound; Fe₂(MoO₄)₃, or the like.

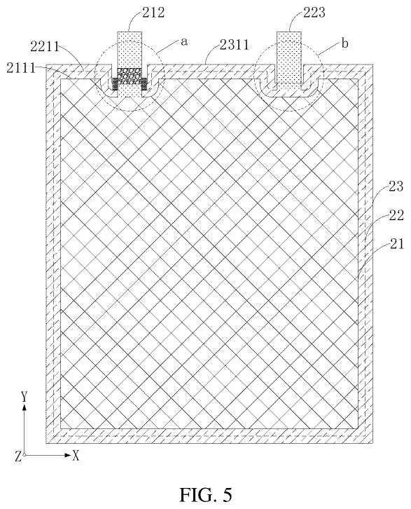

The negative electrode plate 22 includes a negative electrode plate body, a second tab portion 222, and a third tab portion 223. The negative electrode plate body includes a negative current collector (not shown in the drawing) and a first negative active material layer (not shown in the drawing) disposed on at least one surface of the negative current collector. As shown in FIG. 5, in the first direction X, the second tab portion 222 and the third tab portion 223 are spaced apart from each other. Both the second tab portion 222 and the third tab portion 223 are formed together with the negative current collector in one piece. The length by which the second tab portion 222 protrudes out along the second direction Y is less than the length by which the third tab portion 223 protrudes along the first direction X.

The negative current collector, the second tab portion 222, and the third tab portion 223 are typically made of a material that is conductive but without causing chemical changes. Examples of such materials include, but are not limited to, copper, stainless steel, aluminum, nickel, titanium, calcined carbon, or surface-treated aluminum or stainless steel that is formed by treating the surface with carbon, nickel, titanium, silver, or the like. Understandably, the structure of the negative current collector is diversified, and may be, for example, a film, a sheet, a foil, a mesh, a porous body, a foam, or a nonwoven fabric.

In the case that the secondary battery is a lithium secondary battery, the first negative active material layer may include a negative active material. The negative active material may include, but is not limited to: carbon, such as non-graphitizable carbon and graphite-based carbon; complex metal oxide, such as LiₓFe₂O₃ (0≤x≤1), LiₓWO₂ (0≤x≤1), SnₓMe₁₋ₓMe′_{y}O_{z} (Me: Mn, Fe, Pb, Ge; Me′: Al, B, P, Si, Group 1, Group 2, and Group 3 elements in the periodic table, halogen; 0<x≤1; 1≤y≤3; 1≤z≤8), or the like; lithium metal; lithium alloy; silicon-based alloy; tin-based alloy; metal oxide, such as SnO, SnO₂, PbO, PbO₂, Pb₂O₃, Pb₃O₄, Sb₂O₃, Sb₂O₄, Sb₂O₅, GeO, GeO₂, Bi₂O₃, Bi₂O₄, Bi₂O₅, or the like; conductive polymer, such as polyacetylene; lithium cobalt nickel-based material, or the like.

The separator 23 may be a generally known polyolefin separator or may be made by forming an organic or inorganic composite layer on an olefin-based material. The separator insulates the positive electrode from the negative electrode, but the functions of the separator are not particularly limited to separation.

It is hereby noted that, because the structures of the positive electrode plates 21 are substantially similar, the structures of the separators are substantially similar, and the structures of the negative electrode plates 22 are substantially similar, for ease of description, an example is described here in detail in which a composite unit is formed by stacking one positive electrode plate 21, one separator 23, and one negative electrode plate 22.

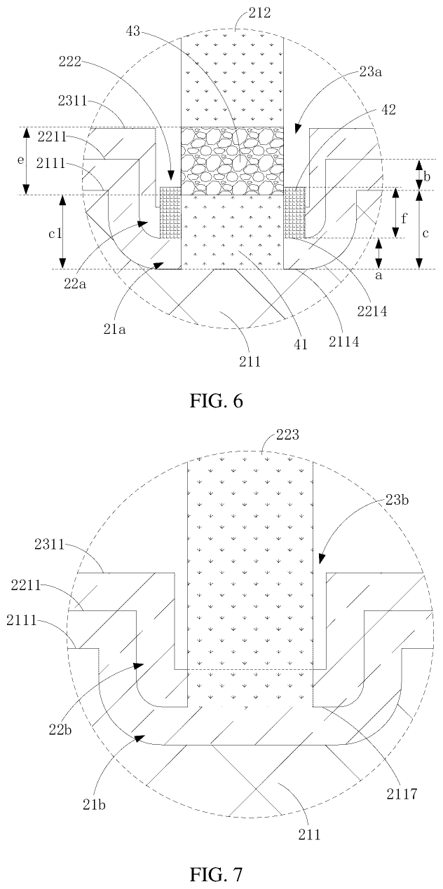

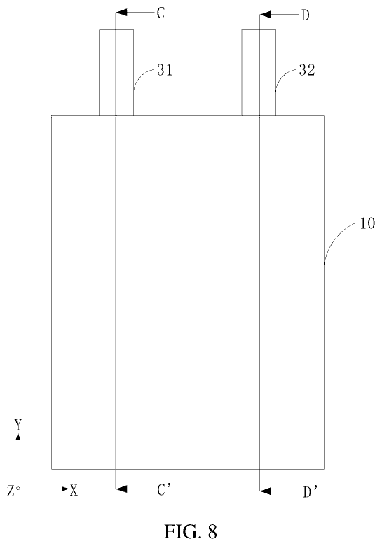

FIG. 5 is a schematic structural diagram of a composite unit of an electrode assembly. FIG. 6 is a close-up view of a part a in FIG. 5. FIG. 7 is a close-up view of a part b in FIG. 5. Referring to FIG. 6 and FIG. 7 together with the example shown in FIG. 5, in some embodiments, the positive electrode plate body 211 includes a first edge 2111 in the second direction Y. The first edge 2111 is provided with a first notch 21a and a second notch 21b spaced apart from each other along the first direction X.

The first notch 21a includes a first lateral edge (not shown in the drawing), a second lateral edge (not shown in the drawing), and a first bottom edge 2114. The first lateral edge is connected to one end of the first bottom edge 2114 along the first direction X. The second lateral edge is connected to the other end of the first bottom edge 2114 along the first direction X. The first lateral edge and the second lateral edge are arranged opposite to each other along the first direction X.

The first tab portion 212 is located at the first notch 21a, and is formed together with the first bottom edge 2114 in one piece. In addition, one lateral edge of the first tab portion 212 along the first direction X is spaced apart from the first lateral edge. The other lateral edge of the first tab portion 212 along the first direction X is spaced apart from the second lateral edge. Along the second direction Y, the first tab portion 212 exceeds the first edge 2111. In the accommodation cavity, the first tab portion 212 may be electrically connected to the positive tab 31.

The negative electrode plate body includes a second edge 2211 in the second direction Y. The second edge 2211 and the first edge 2111 are located on the same side of the electrode assembly 20. The second edge 2211 is provided with a third notch 22a and a fourth notch 22b spaced apart from each other along the first direction X.

The third notch 22a includes a third lateral edge (not shown in the drawing), a fourth lateral edge (not shown in the drawing), and a second bottom edge 2214. The third lateral edge is connected to one end of the second bottom edge 2214 along the first direction X. The fourth lateral edge is connected to the other end of the second bottom edge 2214 along the first direction X. The third lateral edge and the fourth lateral edge are arranged opposite to each other along the first direction X.

The second tab portion 222 is located at the third notch 22a, and is formed together with the second bottom edge 2214 in one piece. In addition, one lateral edge of the second tab portion 222 along the first direction X is spaced apart from the third lateral edge. The other lateral edge of the second tab portion 222 along the first direction X is spaced apart from the fourth lateral edge.

The fourth notch 22b includes a fifth lateral edge (not shown in the drawing), a sixth lateral edge (not shown in the drawing), and a third bottom edge 2217. The fifth lateral edge is connected to one end of the third bottom edge 2217 along the first direction X. The sixth lateral edge is connected to the other end of the third bottom edge 2217 along the first direction X. The fifth lateral edge and the sixth lateral edge are arranged opposite to each other along the first direction X.

The third tab portion 223 is located at the fourth notch 22b, and is formed together with the third bottom edge 2217 in one piece. In addition, one lateral edge of the third tab portion 223 along the first direction X is spaced apart from the fifth lateral edge. The other lateral edge of the third tab portion 223 along the first direction X is spaced apart from the sixth lateral edge. Along the second direction Y, the third tab portion 223 exceeds the second edge 2211. In the accommodation cavity, the third tab portion 223 may be electrically connected to the negative tab 32.

Viewed along the third direction Z, a projection of the third notch 22a lies within a projection of the first notch 21a, and a projection of the fourth notch 22b lies within a projection of the second notch 21b. Along the third direction Z, a projection of the first tab portion 212 partially overlaps with a projection of the second tab portion 222, and the length of the second tab portion 222 in the second direction Y is less than the length of the first tab portion 212 in the second direction Y.

In contrast to the prior art in which the length of each tab portion is basically kept unchanged, in the first tab portion 212 and the third tab portion 223 of the secondary battery of this application, the length by which each tab portion extends out of the electrode plate body along the second direction Y becomes shorter, thereby reducing the wobbling amplitude of the first tab portion 212, the second tab portion 222, and the third tab portion 223 during the transfer, and in turn, reducing the phenomena that the wobbling of the first tab portion 212, the second tab portion 222, and the third tab portion 223 causes lifting of the root portion and that the lifting spreads to the electrode plate body containing the tab portion. On this basis, because the length of the second tab portion 222 in the second direction Y is less than the length of the first tab portion 212 in the second direction Y, two adjacent second tab portions 222 can constrain the first tab portion 212 sandwiched in between, so that the wobbling amplitude of the first tab portion 212 can be further suppressed. Therefore, the secondary battery of this application can reduce the phenomena that the adhesion between the positive or negative electrode plate and the separator 23 is reduced, thereby improving the yield rate of the secondary battery.

Understandably, the specific positions of the first notch 21a and the second notch 21b may be adaptively adjusted according to actual needs. The two notches are not necessarily arranged at the first edge 2111, but may be disposed in other positions as long as the first notch 21a and the second notch 21b are spaced apart from each other along the first direction X. For example, the first notch 21a and the second notch 21b may be arranged at an edge of the positive electrode plate body 211 on one side opposite to the first edge 2111 in the second direction Y. Similarly, the third notch 22a and the fourth notch 22b may be arranged at an edge of the negative electrode plate body on one side opposite to the second edge 2211 in the second direction Y.

As shown in FIG. 6, in some embodiments, the secondary battery includes a second negative active material layer 42. The second negative active material layer 42 is disposed on two opposite surfaces of the second tab portion 222 in the third direction Z. The second negative active material layer 42 and the first negative active material layer are formed in one piece.

The secondary battery includes a second positive active material layer 41. The second positive active material layer 41 is disposed on two opposite surfaces of the first tab portion 212 in the third direction Z and is disposed close to the first bottom edge 2114. The second positive active material layer 41 and the first positive active material layer are formed in one piece.

A distance from the first edge 2111 to the first bottom edge 2114 is c mm, and a distance from one end, away from the first bottom edge 2114, of the second positive active material layer 41 to the first bottom edge 2114 is c1 mm, satisfying: 0<|c1−c|≤0.05 mm.

It is hereby noted that the second negative active material layer 42 mentioned here is similar to the aforementioned first negative active material layer in structure. For the structure of the second negative active material layer 42, reference may be made to the relevant description of the first negative active material layer, the details of which are omitted here. The second positive active material layer 41 mentioned here is similar to the aforementioned first positive active material layer in structure. For the structure of the second positive active material layer 41, reference may be made to the relevant description of the first positive active material layer, the details of which are omitted here.

Such arrangement achieves the following beneficial effects: on the premise that other conditions of the secondary battery remain basically the same, the second tab portion 222 and a partial region, corresponding to the second tab portion 222, of the first tab portion can be sufficiently utilized. With more active material added, the total area of the active material can be increased, thereby increasing the energy density of the secondary battery. In addition, when a second positive active material layer 41 is disposed at one end, close to the first bottom edge 2114, of the first tab portion 212, because the second tab portion 222 is also provided with the second negative active material layer 42, the normal length by which the second bottom edge 2214 extends beyond the first bottom edge 2114 along the second direction Y can be maintained without a need to move the entire positive electrode plate 21 downward. The downward movement of the entire positive electrode plate leads to an excessive length by which the second edge 2211 extends beyond the first edge 2111 along the second direction Y, and therefore, the gap at the head of the secondary battery becomes larger, and results in a decrease in the volumetric energy density of the secondary battery.

Definitely, the second negative active material layer 42 may be replaced by an adhesive component in order to alleviate the decrease in the adhesion between the positive or negative electrode plate 22 and the separator 23. In other words, in some embodiments, the secondary battery includes an adhesive component (not shown in the drawing). In the third direction Z, the adhesive component is adhesively fixed between the second tab portion 222 and the separator 23. In this way, the adhesive component bonds the second tab portion 222 and the separator 23 together to increase the structural strength of the second tab portion 222, thereby enhancing the restraint effect on the first tab portion 212, and further alleviating the decrease in the adhesion between the positive or negative electrode plate and the separator 23.

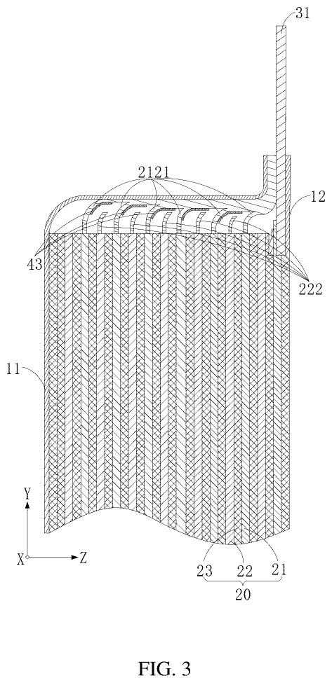

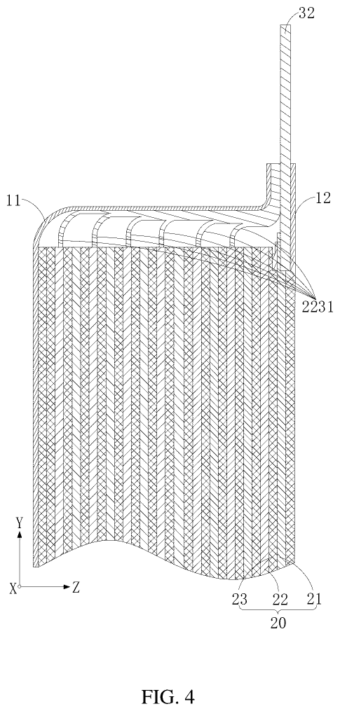

Referring to FIG. 6 and FIG. 7 together with the example shown in FIG. 3 or FIG. 4, along the second direction Y, a part, exceeding the first edge 2111, of the first tab portion 212 of the positive electrode plate 21 is a first exceeding part 2121. At least a part of the first exceeding part 2121 is configured to bend and extend along the third direction Z and be electrically connected to one end of the positive tab 31. The other end of the positive tab 31 protrudes out of the packaging bag 10. The positive tab 31 is directly led out of the packaging bag 10.

Along the second direction Y, a part, exceeding the second edge 2211, of the third tab portion 223 of the negative electrode plate 22 is a second exceeding part 2231. At least a part of the second exceeding part 2231 is configured to bend and extend along the third direction Z and be electrically connected to one end of the negative tab 32. The other end of the negative tab 32 protrudes out of the packaging bag 10. The negative tab 32 is directly led out of the packaging bag 10.

In the above technical solution, in the third direction Z, the first notch 21a and the third notch 22a overlap to form a tab portion accommodation space for accommodating the bent first tab portion 212. Similarly, in the third direction Z, the second notch 21b and the fourth notch 22b overlap to form a tab portion accommodation space for accommodating the bent third tab portion 223. The bending of the first tab portion 212 and the third tab portion 223 can reduce the space occupied by the electrode assembly 20, thereby reducing the head gap of the secondary battery, and in turn, increasing the volumetric energy density of the secondary battery.

Understandably, the method of connection between the first tab portion 212 and the positive tab 31 is not particularly limited herein. The electrical connection between the first tab portion and the positive tab may be implemented by means including but not limited to welding, conductive adhesive bonding, or riveting. The method of connection between the third tab portion 223 and the negative tab 32 is similar, the details of which are omitted here.

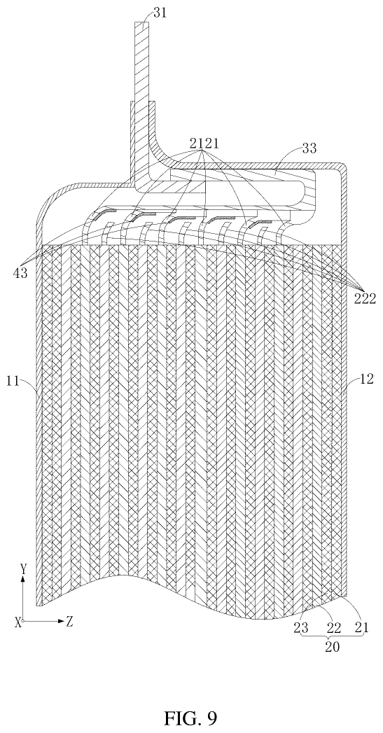

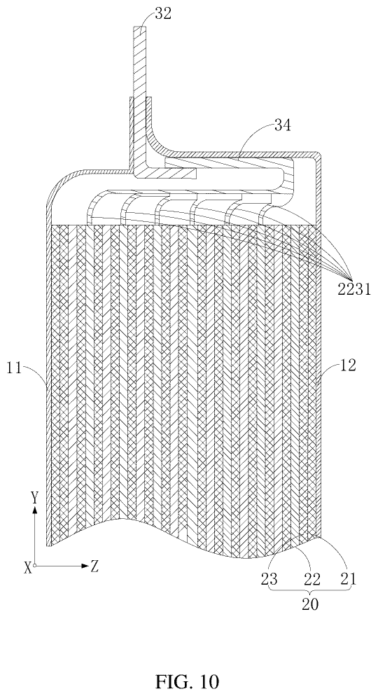

Alternatively, referring to FIG. 8 to FIG. 10 together with the example shown in FIG. 3 or FIG. 4, a difference from the above embodiment is: the secondary battery includes a first tab portion convergence section 33 and a third tab portion convergence section 34.

The first tab portion 212 is curved, and is bent toward the third direction Z, extends through the first notch 21a and the third notch 22a, and then converges to form a first tab portion convergence section 33. One end of the first tab portion convergence section 33 is electrically connected to one end of the positive tab 31. The positive tab 31 is also curved, and the other end of the positive tab passes through the sealing portion and extends out of the packaging bag 10.

The third tab portion 223 is curved, and is bent toward the third direction Z, extends through the fourth notch 22b and the second notch 21b, and then converges to form a third tab portion convergence section 34. One end of the third tab portion convergence section 34 is electrically connected to one end of the negative tab 32. The negative tab 32 is also curved, and the other end of the negative tab passes through the sealing portion and extends out of the packaging bag 10.

As shown in FIG. 6 or FIG. 7, in some embodiments, the separator 23 includes a third edge 2311 in the second direction Y. The third edge 2311, the second edge 2211, and the first edge 2111 are located on the same side of the electrode assembly 20.

The third edge 2311 is provided with a fifth notch 23a and a sixth notch 23b spaced apart from each other along the first direction X. Viewed along the third direction Z, the projection of the fifth notch 23a lies within the projection of the first notch 21a, and the projection of the sixth notch 23b lies within the projection of the second notch 21b.

In this way, the first tab portion 212 is bent toward the third direction Z, extends through the first notch 21a, the fifth notch 23a, and the third notch 22a, and then is electrically connected to the other end of the positive tab 31. The third tab portion 223 is bent toward the third direction Z, extends through the fourth notch 22b, the sixth notch 23b, and the second notch 21b, and then is electrically connected to the other end of the negative tab 32.

In this way, the entire head of the separator 23 is not prone to bend as driven by the bending of the first tab portion 212 and the second tab portion 222, thereby reducing the probability of a short circuit between the positive electrode plate body and the negative electrode plate body caused by the inward bending of the head portion of the separator 23.

Still referring to FIG. 6, to improve reliability of the secondary battery in use, the secondary battery includes an insulation layer 43. The insulation layer 43 is disposed peripherally on an outer peripheral surface of the first exceeding part 2121 at one end close to the first notch 21a. Viewed along the third direction Z, an edge of the second tab portion 222 on one side away from the third notch 22a lies within the projection of the insulation layer 43. The outer peripheral surface of the first exceeding part 2121 at one end close to the first notch 21a is provided with an insulation layer 43. Therefore, even if the burrs pierce the separator 23, the burrs are not prone to directly contact the first exceeding part 2121 of an opposite polarity, thereby improving the reliability of the secondary battery in use.

As an example, the insulation layer 43 may be a ceramic coating layer. The ceramic coating layer includes inorganic particles and a binder. The inorganic particles include at least one of aluminum oxide, silicon dioxide, magnesium oxide, barium titanium oxide, titanium dioxide, zirconium dioxide, barium oxide, or boehmite.

Still referring to FIG. 6, in some embodiments, (c−a)≤f. With the value of f falling within this range, the risk of lithium plating of the secondary battery is relatively low, a relatively high percentage increase in the adhesion and the volumetric energy density can be maintained. In the relational expression above, along the second direction Y, the distance from the first edge 2111 to the first bottom edge 2114 of the first notch 21a is c mm; along the second direction Y, the distance from the second bottom edge 2214 of the third notch 22a to the first bottom edge 2114 is a mm; and, along the second direction Y, the extension length of the second tab portion 222 from the second bottom edge 2214 is f mm.

Further, f≤Min{(b+c−a)/2, (e+c−a)}, where, along the second direction Y, the distance between the second edge 2211 and the first edge 2111 is b mm; and, along the second direction Y, a coating length of the insulation layer 43 is e mm. With the value of f falling within this range, the length by which the second tab portion 222 extends out in the second direction Y is less likely to cause the bent first tab portion 212 to additionally occupy the head gap of the secondary battery, a relatively high percentage increase in the adhesion can be maintained, and a percentage increase in the volumetric energy density is also achieved.

This application is described in more detail below with reference to embodiments and comparative embodiments. Various tests and evaluations are performed by the following methods. In addition, unless otherwise specified, the word “parts” means parts by mass, and the symbol “%” means a percentage by mass. Understandably, such embodiments are merely intended to illustrate this application but not to limit the scope of this application.

### EMBODIMENT 1-1

### Preparing a Positive Electrode Plate

Mixing lithium cobalt oxide as a positive active material, acetylene black as a conductive agent, and polyvinylidene difluoride as a binder at a mass ratio of 94:3:3, and adding N-methyl-pyrrolidone as a solvent to form a slurry in which the solid content is 75%, and stirring well. Using a 12 μm-thick aluminum foil as a positive current collector. Dividing the aluminum foil into a blank region and a coating region along the width direction of the aluminum foil. Applying the slurry evenly onto the coating regions on the surfaces of the aluminum foil on the two sides opposite to each other along the thickness direction of the foil. Applying a ceramic coating layer onto a part of the blank regions of the aluminum foil on the two sides of the foil, where the part of the blank regions closely contiguous to the coating regions. Drying the slurry at 90° C., and cold-pressing the foil to obtain a positive electrode plate coated with a 100 μm-thick positive active material layer.

### Preparing a Negative Electrode Plate

Mixing artificial graphite as a negative active material and styrene-butadiene rubber as a binder at a mass ratio of 98:2, and adding deionized water as a solvent to form a slurry in which the solid content is 70%, and stirring well. An 8 μm-thick copper foil is used as a negative current collector. Dividing the copper foil into a blank region and a coating region along the width direction of the copper foil. Applying the slurry evenly onto the coating regions of the copper foil on the two sides opposite to each other along the thickness direction of the foil. Drying the slurry at 110° C., and cold-pressing the foil to obtain a negative electrode plate coated with a 150 μm-thick negative active material layer.

### Preparing a Separator

Mixing aluminum oxide and a polyacrylate ester at a mass ratio of 90:10, and dissolving the mixture in deionized water to form a ceramic slurry in which the solid content is 50%. Subsequently, coating one side of a porous substrate (polyethylene, thickness: 7 μm; average pore diameter: 0.073 μm; porosity: 26%) with the ceramic slurry evenly by a micro-gravure coating method. Drying the slurry to obtain a double-layer structure that includes a ceramic coating layer and a porous substrate. The thickness of the ceramic coating layer is 2.5 μm.

Mixing polyvinylidene difluoride and polyacrylate at a mass ratio of 96:4, and dissolving the mixture in deionized water to form a polymer slurry with a solid content of 50%. Subsequently, coating both surfaces of the double-layer structure of the ceramic coating layer and the porous substrate with the polymer slurry evenly by a micro-gravure coating method, and drying the slurry to obtain a separator, in which the thickness of a single coating layer formed by the polymer slurry is 2 μm.

### Preparing an Electrolyte Solution

Mixing ethylene carbonate (EC), diethyl carbonate (DEC), propylene carbonate (PC), propyl propionate (PP), and vinylene carbonate (VC) at a mass ratio of 20:30:20:28:2 in an environment with a moisture content less than 10 ppm, so as to obtain a nonaqueous organic solution. Adding lithium hexafluorophosphate (LiPF₆) into the nonaqueous organic solvent to dissolve, and stirring well to obtain an electrolyte solution. The mass ratio between LiPF₆ and the nonaqueous organic solvent is 8:92.

### Assembling an Electrode Assembly

First, die-cutting the positive electrode plate. Die-cutting the blank region along a boundary path between the ceramic coating layer and the coating region to form a first tab portion of a preset shape. Subsequently, cutting out a notch of a preset shape on the left and right sides of the first tab portion through die-cutting so that the notches on the two sides jointly form a first notch. Simultaneously or sequentially, cutting out a second notch of a preset shape through die-cutting at a position at which the first tab portion is separated along the first edge. At this time, the ceramic coating layer located on the outer peripheral surface of the first tab portion at one end closely contiguous to the first bottom edge is the insulation layer, and a part, closely contiguous to the ceramic coating layer, of the positive active material layer of the first tab portion is the second positive active material layer.

Second, die-cutting the negative electrode plate. Die-cutting the blank region along a boundary path between the blank region and the coating region to form a third tab portion of a preset shape. Simultaneously or sequentially, through die-cutting, cutting out a third notch in the coating region and a second tab portion disposed at the third notch. At this time, the second tab portion is coated with a negative active material layer, and the negative active material layer is the second negative active material layer.

Disposing a separator on a front side and a back side of each of a plurality of negative electrode plates, and hot-pressing the electrode plate into a layered body, and then cutting the electrode plate into a plurality of composite units of a preset shape by using a laser beam.

Finally, stacking the composite unit and the positive electrode plate, and hot-pressing the electrode plate into an electrode assembly. Viewed along the third direction, the projection of the third notch lies within the projection of the first notch, and the projection of the fourth notch lies within the projection of the second notch. In addition, along the third direction Z, the projection of the first tab portion at least partially overlaps with the projection of the second tab portion, and the length of the second tab portion in the second direction is less than the length of the first tab portion in the second direction.

### Assembling a Secondary Battery

Fixing the positive tab to a plurality of first tab portions of the electrode assembly by means including but not limited to welding. Fixing the negative tab to a plurality of third tab portions of the electrode assembly by means including but not limited to welding. Putting the electrode assembly, which is formed by stacking, into a packaging bag. Dehydrating the electrode assembly at 80° C., and then injecting the electrolyte solution, and sealing the packaging bag. Performing steps such as chemical formation, degassing, and edge trimming to obtain a finished secondary battery of 33 mm in width, 78.3 mm in length, and 5.8 mm in thickness.

The following describes the test method of parameters in each embodiment of this application.

### Method for Determining the Volumetric Energy Density

Putting the secondary battery into a 25° C.±2° C. thermostat, and leaving the battery to stand for 30 minutes so that the temperature of the secondary battery is constant. Charging the constant-temperature secondary battery at a constant current of 0.5 C until a full-charge voltage, and then charging the battery at a constant voltage of the full-charge voltage until the current drops to 0.05 C. Subsequently, discharging the battery at a current of 0.2 C until the voltage drops to 3.0 V, and recording the discharge energy.

$$Volumetric energy density = discharge energy / ( length of secondary battery \times width of secondary battery \times thickness of secondary battery ) .$$

$$Percentage increase in volumetric energy density = [ ( volumetric energy density of the secondary battery in each embodiment - volumetric energy density of the secondary battery in the Comparative Embodiment 1 ‐ 1 ) / volumetric energy density of the secondary battery in the Comparative Embodiment 1 ‐ 1 ] \times 100 \% .$$

### Testing the Lithium Plating

Keeping a secondary battery at a 25° C. test temperature for 30 minutes, and then charging the battery to 4.5 V progressively according to the following charging steps:
(1) 6 C CC to 4.2 V;
(2) 5 C CC to 4.23 V;
(3) 4 C CC to 4.3 V;
(4) 3 C CC to 4.5 V;
(5) 2 C CC to 4.5 V, CV to 0.05 C.

Leaving the battery to stand for 10 minutes, and then discharging the battery according to the following step:
0.2 C DC to 3 V.

The above charge and discharge process completes one cycle. Repeating the above steps for 100 cycles, and then disassembling the battery that is a fully charged state (the full charged state means that the battery reaches a nominal voltage of 4.5 V) and taking out a negative electrode plate. Determining occurrence of lithium plating if a lithium deposition area on the surface of the negative electrode plate is greater than or equal to 2 mm².

### Testing the Adhesion between the Separator, the Positive Electrode Plate, and the Negative Electrode Plate

Disassembling a secondary battery and taking out a composite unit of the separator, positive electrode plate, and negative electrode plate. Cutting the composite unit into specimens of 33 mm×78.3 mm in size. Bonding a specimen to a flat glass sheet. Using a gripper to clamp one end of the separator, and peeling the separator off with a constant force. The corresponding adhesion force is displayed in the corresponding peel strength test instrument (the adhesion force is measured at normal temperature (25° C.) according to the 180° peel strength test standard).

Percentage increase in adhesion=[(adhesion between the separator, positive electrode plate, and negative electrode plate of the secondary battery in each embodiment−adhesion between the separator, positive electrode plate, and negative electrode plate of the secondary battery in Embodiment 1-1)/adhesion between the separator, positive electrode plate, and negative electrode plate of the secondary battery in Embodiment 1-1]×100%. The measured adhesion between the separator, positive electrode plate, and negative electrode plate of the secondary battery in Embodiment 1-1 is 5.5 N.

### COMPARATIVE EMBODIMENT 1-1

The difference from Embodiment 1-1 is that the first edge is not provided with the first notch or the second notch; the second edge is not provided with the third notch or the fourth notch; and the negative electrode plate is not provided with the second tab portion. In other words, the positive electrode plate includes only a first tab portion, and the negative electrode plate includes only a third tab portion.

### COMPARATIVE EMBODIMENT 1-2

The difference from Embodiment 1-1 is that the first edge is provided with a first notch and a second notch; and the second edge is provided with a third notch and a fourth notch. However, the negative electrode plate is not provided with a second tab portion.

TABLE 1

| | | | Percentage increase | |
|---|---|---|---|---|
| | Are a first notch and a second | | in adhesion between | |
| | notch provided at the first edge? | Is a second tab | separator, positive | Percentage increase in |
| | Are a third notch and a fourth | portion | electrode plate, and | volumetric energy density |
| | notch provided at the second | provided at the | negative electrode | (based on secondary |
| Serial number | edge? | third notch? | plate | battery length 78.3 mm) |
| Comparative | No | No | 30% | 0 |
| Embodiment 1-1 | | | | |
| Comparative | Yes | No | 41.8% | 1.4 |
| Embodiment 1-2 | | | | |
| Embodiment 1-1 | Yes | Yes | 100% | 2 |

As shown in Table 1, as can be seen from Comparative Embodiments 1-1 and 1-2 versus Embodiment 1-1, the percentage increase in the adhesion between the separator, positive electrode plate, and negative electrode plate as well as the percentage increase in the volumetric energy density in Embodiment 1-1 are superior. A possible reason is: first, the two adjacent second tab portions can constrain the first tab portion sandwiched in between, so that the wobbling amplitude of the first tab portion can be suppressed, thereby alleviating the decline in the adhesion between the positive or negative electrode plate and the separator; second, the presence of each notch can provide a space for each bent tab portion, thereby reducing the head gap of the secondary battery and increasing the volumetric energy density of the secondary battery.

### EMBODIMENTS 1-2 to 1-7

The difference from Embodiment 1-1 lies in the parameters shown in the table. The volumetric energy density, lithium plating, and adhesion are tested for each embodiment. The parameters and test results of each embodiment are shown in Table 2.

TABLE 2

| Serial number | a (mm) | b (mm) | c (mm) | d (mm) | e (mm) | f (mm) | c − a | (b + c − a)/2 |
|---|---|---|---|---|---|---|---|---|
| Embodiment 1-1 | 0 | 0.82 | 0.3 | 1.12 | 1.8 | 0.15 | 0.3 | 0.6 |
| Embodiment 1-2 | 0.5 | 0.82 | 0.7 | 1.02 | 1.8 | 0.35 | 0.2 | 0.51 |
| Embodiment 1-3 | 0.5 | 0.82 | 0.7 | 1.02 | 1.8 | 0.2 | 0.2 | 0.51 |
| Embodiment 1-4 | 0.5 | 0.82 | 0.7 | 1.02 | 1.8 | 0.51 | 0.2 | 0.51 |
| Embodiment 1-5 | 0.3 | 0.82 | 0.8 | 1.32 | 1.8 | 0.6 | 0.5 | 0.66 |
| Embodiment 1-6 | 0.4 | 0.9 | 0.8 | 1.3 | 1.8 | 0.5 | 0.4 | 0.65 |
| Embodiment 1-7 | 0.5 | 0.8 | 0.7 | 1 | 1.8 | 0.35 | 0.2 | 0.5 |
| Embodiment 1-8 | 0.6 | 1.8 | 0.9 | 1.9 | 0.6 | 0.6 | 0.1 | 0.95 |
| Embodiment 1-9 | 0.6 | 1.8 | 0.9 | 1.9 | 0.6 | 1 | 0.1 | 0.95 |

| | | Percentage increase in | Increase percentage of | Does lithium plating |
|---|---|---|---|---|
| | | adhesion between separator, | volumetric energy density | occur on negative |
| | | positive electrode plate, and | (based on a secondary | electrode plate after |
| Serial number | e + c − a | negative electrode plate | battery length 78.3 mm) | 100 cycles? |
| Embodiment 1-1 | 2.1 | 42.6% | 1.41% | Yes |
| Embodiment 1-2 | 2 | 100% | 0.98% | No |
| Embodiment 1-3 | 2 | 100% | 1.05% | No |
| Embodiment 1-4 | 2 | 100% | 0.75% | No |
| Embodiment 1-5 | 2.3 | 114.3% | 1.05% | No |
| Embodiment 1-6 | 2.2 | 114.3% | 1.05% | No |
| Embodiment 1-7 | 1.8 | 100% | 0.98% | No |
| Embodiment 1-8 | 0.7 | 129.6% | 0.47% | No |
| Embodiment 1-9 | 0.7 | 130.9% | −0.1% | No |

As shown in Table 2, in Embodiment 1-1, f<c−a, and lithium plating occurs on the surface of the negative electrode plate of the secondary battery after 100 cycles. A possible reason is that the first bottom edge is aligned with the second bottom edge, and no extra margin is reserved at the second bottom edge of the negative electrode plate and the positive electrode plate. During charging of the secondary battery, lithium ions are excessively deintercalated from the positive electrode plate and are unable to be fully intercalated into the negative active material, thereby resulting in lithium plating on the surface of the negative electrode plate.

As can be seen from Embodiments 1-2 to 1-9 versus Embodiment 1-1, when c−a≤f, the percentage increase in the adhesion of each secondary battery in Embodiments 1-2 to 1-9 is higher than the percentage increase in the adhesion of the secondary battery in Embodiment 1-1.

Specifically, the adhesion between the positive or negative electrode plate and the separator is jointly affected by the extension-out length of the second tab portion in the second direction and the depth of the first notch in the second direction. A possible reason is that a larger depth of the first notch in the second direction leads to a larger area of a region of the positive or negative electrode plate, where the region surrounds the third notch, and therefore, it is more difficult for the wobbling of the root portion of the second tab portion to drive the peripheral electrode plate region to lift up. In addition, a greater extension-out length of the second tab portion in the second direction leads to a more significant constraint on the first tab portion sandwiched between the two second tab portions. Therefore, the effect of suppressing the wobbling amplitude is greater, thereby resulting in a smaller decline in the adhesion between the positive or negative electrode plate and the separator.

Still referring to Table 2, as can be seen from Embodiments 1-1 to 1-8 versus Embodiment 1-9, when f>(b+c−a)/2, the percentage increase in the volumetric energy density of the secondary battery in Embodiment 1-7 is inferior to the percentage increase in the volumetric energy density of any secondary battery in Embodiments 1-1 to 1-6. That is because the length by which the second tab portion extends out in the second direction goes beyond the threshold. Consequently, the bent first tab portion additionally occupies the gap at the head of the secondary battery, thereby causing the percentage increase in the volumetric energy density of the secondary battery to be significantly inferior to that in Embodiments 1-1 to 1-8, and even Comparative Embodiment 1-1. This phenomenon is particularly prominent in Embodiments 1-6 and 1-7 in which only the value of fis changed.

In summary, when c−a≤f≤Min {(b+c−a)/2, (e+c−a)}, the secondary battery not only maintains a superior percentage increase in adhesion, but also exhibits a percentage increase in the volumetric energy density.

Based on the same inventive concept, an embodiment of this application provides an electrical device. The electrical device includes a load and a secondary battery disclosed in any one of the above embodiments. The secondary battery is configured to supply power to the load.

The electrical device may be implemented in various specific forms, for example, an unmanned aerial vehicle, an electric vehicle, an electric cleaning tool, an energy storage product, an electric bicycle, an electric navigation tool, or another electronic product. In practical scenarios, the electrical device may specifically be, but is not limited to, a laptop computer, pen-inputting computer, mobile computer, e-book player, portable phone, portable fax machine, portable photocopier, portable printer, stereo headset, video recorder, liquid crystal display television set, handheld cleaner, portable CD player, mini CD-ROM, transceiver, electronic notepad, calculator, memory card, portable voice recorder, radio, backup power supply, motor, automobile, motorcycle, power-assisted bicycle, bicycle, lighting appliance, toy, game console, watch, electric tool, flashlight, camera, large household storage battery, lithium-ion capacitor, or the like.

A person skilled in the art understands that the structures according to the embodiments of this application are not only applicable to the components specially designed for mobile purposes, but also applicable to fixed-type electrical devices. Because the electrical device contains the secondary battery disclosed in any one of the above embodiments, the electrical device can achieve the beneficial effects of the secondary battery disclosed in the corresponding embodiment.

Described above are merely some embodiments of this application without limiting the patent scope of this application. Any and or all equivalent structural variations and equivalent process variations made by using the content of the specification and the drawings of this application, and the content hereof used directly or indirectly in any other related technical fields, still fall within the patent protection scope of this application.

What is claimed is:

1. A secondary battery, comprising an electrode assembly having a stacked structure; the electrode assembly comprises a positive electrode plate, a negative electrode plate, and a separator disposed between the positive electrode plate and the negative electrode plate; wherein,
the positive electrode plate comprises a positive electrode plate body and a first tab portion;
the positive electrode plate body comprises a first edge, the first edge is provided with a first notch and a second notch, the first notch and the second notch are spaced apart from each other along a first direction;
the first tab portion is located at the first notch and is formed together with the positive electrode plate body in one piece;
the first tab portion extends beyond the first edge along a second direction;
the negative electrode plate comprises a negative electrode plate body, a second tab portion, and a third tab portion;
the negative electrode plate body comprises a second edge, the second edge is provided with a third notch and a fourth notch;
the second tab portion is located at the third notch and is formed together with the negative electrode plate body in one piece;
the third tab portion is located at the fourth notch and is formed together with the negative electrode plate body in one piece;
the third tab portion extends beyond the second edge along the second direction;
viewed along a third direction, a projection of the third notch lies within a projection of the first notch;
viewed along the third direction, a projection of the fourth notch lies within a projection of the second notch;
viewed along the third direction, a projection of the first tab portion at least partially overlaps with a projection of the second tab portion;
a length of the second tab portion in the second direction is less than a length of the first tab portion in the second direction; and
the third direction, the second direction, and the first direction are perpendicular to each other; the third direction is a stacking direction of the negative electrode plate and the positive electrode plate.

2. The secondary battery according to claim 1, wherein,
the negative electrode plate body comprises a negative current collector and a first negative active material layer disposed on at least one surface of the negative current collector;
the positive electrode plate body comprises a positive current collector and a first positive active material layer disposed on at least one surface of the positive current collector;
the secondary battery further comprises a second negative active material layer;
in the third direction, the second negative active material layer is disposed on two opposite surfaces of the second tab portion;
the second negative active material layer and the first negative active material layer are formed in one piece;
the secondary battery comprises a second positive active material layer;
the first notch comprises a first bottom edge;
the second positive active material layer is disposed on two opposite surfaces of the first tab portion in the third direction;
the second positive active material layer and the first positive active material layer are formed in one piece; and
viewed along the third direction, a projection of the second negative active material layer at least partially overlaps with a projection of the second positive active material layer.

3. The secondary battery according to claim 2, wherein, viewed along the third direction, the projection of the second positive active material layer lies within the projection of the second negative active material layer.

4. The secondary battery according to claim 2, wherein,
in the second direction, a distance from the first edge to the first bottom edge is c mm;
a distance from one end of the second positive active material layer to the first bottom edge is c1 mm, the one end of the second positive active material layer being facing away from the first bottom edge; and
0<|c1−c|≤0.05 mm.

5. The secondary battery according to claim 1, wherein,
the secondary battery comprises an adhesive component;
in the third direction, the adhesive component is adhesively fixed between the second tab portion and the separator.

6. The secondary battery according to claim 2, wherein,
the secondary battery further comprises a packaging bag, a positive tab, and a negative tab;
the electrode assembly is accommodated in the packaging bag;
the electrode assembly includes a plurality of positive electrode plates, a plurality of negative electrode plates, and a plurality of separators;
along the third direction, the plurality of positive electrode plates and the plurality of negative electrode plates are alternately stacked;
one of the plurality of separators is sandwiched between each positive electrode plate and an adjacent negative electrode plate;
along the second direction, a part of the first tab portion extending beyond the first edge is a first exceeding part; at least a part of the first exceeding part is configured to bend and extend along the third direction and be electrically connected to the positive tab; and
along the second direction, a part of the third tab portion extending beyond the second edge is a second exceeding part; at least a part of the second exceeding part is configured to bend and extend along the third direction and be electrically connected to the negative tab.

7. The secondary battery according to claim 6, wherein,
the secondary battery comprises an insulation layer;
the insulation layer is disposed peripherally on an outer peripheral surface of the first exceeding part; and
viewed along the third direction, an edge of the second tab portion on one side facing away from the third notch lies within a projection of the insulation layer.

8. The secondary battery according to claim 7, wherein,
(c−a)≤f, wherein,
along the second direction, the third notch comprises a second bottom edge, and a distance from the second bottom edge to the first bottom edge is a mm; and
along the second direction, the second tab portion extends from the second bottom edge by a length of f mm.

9. The secondary battery according to claim 8, wherein,
f≤Min{(b+c−a)/2, (e+c−a)}; wherein,
along the second direction, a distance between the second edge and the first edge is b mm; and
along the second direction, a coating length of the insulation layer is e mm.

10. The secondary battery according to claim 7, wherein, the insulation layer is a ceramic coating layer.

11. The secondary battery according to claim 1, wherein,
the separator comprises a third edge;
the third edge, the second edge, and the first edge are all located on a same side of the electrode assembly;
the third edge is provided with a fifth notch and a sixth notch;
viewed along the third direction, a projection of the fifth notch lies within the projection of the first notch; and
viewed along the third direction, a projection of the sixth notch lies within the projection of the second notch.

12. An electrical device, wherein, the electrical device comprises a secondary battery, the secondary battery comprises an electrode assembly having a stacked structure; the electrode assembly comprises a positive electrode plate, a negative electrode plate, and a separator disposed between the positive electrode plate and the negative electrode plate; wherein,
the positive electrode plate comprises a positive electrode plate body and a first tab portion;
the positive electrode plate body comprises a first edge, the first edge is provided with a first notch and a second notch, the first notch and the second notch are spaced apart from each other along a first direction;
the first tab portion is located at the first notch and is formed together with the positive electrode plate body in one piece;
the first tab portion extends beyond the first edge along a second direction;
the negative electrode plate comprises a negative electrode plate body, a second tab portion, and a third tab portion;
the negative electrode plate body comprises a second edge, the second edge is provided with a third notch and a fourth notch;
the second tab portion is located at the third notch and is formed together with the negative electrode plate body in one piece;
the third tab portion is located at the fourth notch and is formed together with the negative electrode plate body in one piece;
the third tab portion extends beyond the second edge along the second direction;
viewed along a third direction, a projection of the third notch lies within a projection of the first notch;
viewed along the third direction, a projection of the fourth notch lies within a projection of the second notch;
viewed along the third direction, a projection of the first tab portion at least partially overlaps with a projection of the second tab portion;
a length of the second tab portion in the second direction is less than a length of the first tab portion in the second direction; and
the third direction, the second direction, and the first direction are perpendicular to each other; the third direction is a stacking direction of the negative electrode plate and the positive electrode plate.

13. The electrical device according to claim 12, wherein,
the negative electrode plate body comprises a negative current collector and a first negative active material layer disposed on at least one surface of the negative current collector;
the positive electrode plate body comprises a positive current collector and a first positive active material layer disposed on at least one surface of the positive current collector;
the secondary battery further comprises a second negative active material layer;
in the third direction, the second negative active material layer is disposed on two opposite surfaces of the second tab portion;
the second negative active material layer and the first negative active material layer are formed in one piece;
the secondary battery comprises a second positive active material layer;
the first notch comprises a first bottom edge;
the second positive active material layer is disposed on two opposite surfaces of the first tab portion in the third direction;
the second positive active material layer and the first positive active material layer are formed in one piece; and
viewed along the third direction, a projection of the second negative active material layer at least partially overlaps with a projection of the second positive active material layer.

14. The electrical device according to claim 13, wherein, viewed along the third direction, the projection of the second positive active material layer lies within the projection of the second negative active material layer.

15. The electrical device according to claim 13, wherein,
in the second direction, a distance from the first edge to the first bottom edge is c mm;
a distance from one end of the second positive active material layer to the first bottom edge is c1 mm, the one end of the second positive active material layer being facing away from the first bottom edge; and
0<|c1−c|≤0.05 mm.

16. The electrical device according to claim 12, wherein,
the secondary battery comprises an adhesive component;
in the third direction, the adhesive component is adhesively fixed between the second tab portion and the separator.

17. The electrical device according to claim 13, wherein,
the secondary battery further comprises a packaging bag, a positive tab, and a negative tab;
the electrode assembly is accommodated in the packaging bag;
the electrode assembly includes a plurality of positive electrode plates, a plurality of negative electrode plates, and a plurality of separators;
along the third direction, the plurality of positive electrode plates and the plurality of negative electrode plates are alternately stacked;
one of the plurality of separators is sandwiched between each positive electrode plate and an adjacent negative electrode plate;
along the second direction, a part of the first tab portion extending beyond the first edge is a first exceeding part; at least a part of the first exceeding part is configured to bend and extend along the third direction and be electrically connected to the positive tab; and
along the second direction, a part of the third tab portion extending beyond the second edge is a second exceeding part; at least a part of the second exceeding part is configured to bend and extend along the third direction and be electrically connected to the negative tab.

18. The electrical device according to claim 17, wherein,
the secondary battery comprises an insulation layer;
the insulation layer is disposed peripherally on an outer peripheral surface of the first exceeding part; and
viewed along the third direction, an edge of the second tab portion on one side facing away from the third notch lies within a projection of the insulation layer.

19. The electrical device according to claim 18, wherein,
(c−a)≤f, wherein,
along the second direction, the third notch comprises a second bottom edge, and a distance from the second bottom edge to the first bottom edge is a mm; and
along the second direction, the second tab portion extends from the second bottom edge by a length of f mm.

20. The electrical device according to claim 19, wherein,
f≤Min{(b+c−a)/2, (e+c−a)}; wherein,
along the second direction, a distance between the second edge and the first edge is b mm; and
along the second direction, a coating length of the insulation layer is e mm.
